(19) United States
(12) Patent Application Publication
(10) Pub. No.: US 2017/0223415 A1
(43) Pub. Date: Aug. 3, 2017

(54) PARTICIPATIVE SPORTS GAME SYSTEM AND METHOD BY REAL-TIME ANALYZING AND PREDICTING

(71) Applicant: Wook Jeon, Seoul (KR)

(72) Inventor: Wook Jeon, Seoul (KR)

(21) Appl. No.: 15/128,586

(22) PCT Filed: Jan. 8, 2015
(86) PCT No.: PCT/KR2015/000184

§ 371 Date: Sep. 23, 2016

(30) Foreign Application Priority Data
Aug. 21, 2014 (KR) 10-2014-0108869
Nov. 10, 2014 (KR) 10-2014-0155430

(51) Int. Cl. H04N 21/4788; H04N 21/234; H04N 21/2187; H04N 21/84; G06N 5/02; H04N 21/61

(52) U.S. Cl. CPC H04N 21/4788; G06N 5/022; H04N 21/6125; H04N 21/2187; H04N 21/84; H04N 21/23424

(57) ABSTRACT

Provided are a server and a user terminal, in which the user terminal is configured to be: provided with the stream of the video in real-time basis from the sports game streaming module and display the received video; provided with the sports game data in real-time basis from the sports game data provision module and display the received data; inputted with the prediction value about the video of the sports game from the user and transmit the received value to the prediction value analysis provision module; provided with the result of the determination from the prediction value analysis provision module and display the received result; and provided with the point from the point provision module according to the result of the determination.

### TECHNICAL FIELD

The present disclosure relates to a sport game system and a sports game method, and more particularly, to a participative sports game system and method by real-time analyzing and predicting.

### BACKGROUND ART

Sports games (matches) are available on not only TVs, but also personal computers (PCs), smart phones, and a variety of media by broadcasting, real-time streaming, and so on. The users of the media can enjoy sports games virtually anywhere without being restricted by time and places.

Moreover, sports match lotteries allow users to enjoy sports in diversified ways as they analyze the sport games and predict the outcome of the game.

Watchers can analyze and predict sports games by considering various parameters including players, conditions of the games, players on the team, directors, and so on. Experts can predict and analyze the winning team of the year, outcomes of the games while watching TV programs, and general audience can also make a prediction and a diverse and deep analysis before each game by means of sports lotteries.

While the users love sports games for the thrill and excitements these provide and also out of enthusiasm to win, it is also true that sports games are now expanding from the emotional area where the users only seek for excitement and fun, into more intellectual area where the users analyze and predict the sports games. The advanced information and communication technologies has also led into the birth of a variety of sports contents based on a media-mobile combination.

The users enjoy sports games not for gambling purpose or sheer recklessness, but through intellectual analysis and insights.

Meanwhile, a professional sports commentator in commenting a game can read the mind of the team's director or predict the next strategy. He or she makes a comprehensive analysis on external factors or flows of the game that can influence the game such as, when or who is going to be replaced, strategy of the director, condition of the player, and so on.

When immersed into a sports game, even general fans have a sufficient data analysis capability about the teams or players they support. Further, advanced media and information and communication equipment enabled technical advancements and generated a variety of demands from the users who watch a sporting event to make sports analysis.

It is now necessary for the broadcasting or streaming services to provide the sports fans not only the simple excitement and thrills, but also intellectual satisfaction.

### DISCLOSURE OF THE INVENTION

### Technical Problem

According to an embodiment, a technical objective is to provide a participative sports game system by real-time analysis and prediction.

Another technical objective is to provide a participative sports game method by real-time analysis and prediction.

### Technical Solution

In order to achieve the above and other objects of the present disclosure, according to a first exemplary embodiment of the present disclosure, a participative sports game system by real-time analysis and prediction is provided, which may include a server including: a sports game streaming module configured to provide, in real-time basis, a stream of a video of a sports game selected by a user; a sports game data accumulation module configured to collect a sports game data corresponding to a game record generated in real-time basis during the sports game; a sports game data provision module configured to provide, in real-time basis, the collected sports game data of the sports game; a sports game data storage module configured to store the sports game data collected in real-time basis; a prediction value analysis provision module configured to receive a prediction value about the sports game from the video provided by the sports game streaming module, determine whether or not the received prediction value is met and provide a result of the determination; and a point provision module configured to provide a point according to the result of the determination provided from the prediction value analysis provision module; and a user terminal configured to be: provided with the stream of the video in real-time basis from the sports game streaming module and display the received video; provided with the sports game data in real-time basis from the sports game data provision module and display the received data; inputted with the prediction value about the video of the sports game from the user and transmit the received value to the prediction value analysis provision module; provided with the result of the determination from the prediction value analysis provision module and display the received result; and provided with the point from the point provision module according to the result of the determination.

The prediction value analysis provision module may be configured to: receive, from the user terminal, a real-time prediction value about a sub-event of the sports game and a prior prediction value about a final outcome of the sports game, determine whether each is met or not, and provide a result of the determination to the user terminal.

The prediction value analysis provision module may be configured to as follows.

The prediction value analysis provision module may be configured to: analyze by comparison the sports game data collected in real-time basis from the sports game data and the prediction value received from the prediction value analysis provision module, to perceive whether or not the sub-event is successful.

According to a second exemplary embodiment of the present disclosure, participative sports game system by real-time analysis and prediction is provided, which may include a server including: a sports game streaming module configured to provide, in real-time basis, a stream of a video of a sports game selected by a user; a sports game data accumulation module configured to collect a sports game data corresponding to a game record generated in real-time basis during the sports game; a sports game data provision module configured to provide, in real-time basis, the collected sports game data of the sports game; a sports game data storage module configured to store the sports game data collected in real-time basis; a prediction value analysis provision module configured to receive a prediction value about the sports game from the video provided by the sports game streaming module, determine whether or not the received prediction value is met and provide a result of the determination; and a point provision module configured to provide a point according to the result of the determination provided from the prediction value analysis provision module; and a user terminal configured to be: provided with the sports game data in real-time basis from the sports game data provision module and display the received data; inputted with the prediction value about the video of the sports game from the user and transmit the received value to the prediction value analysis provision module; provided with the result of the determination from the prediction value analysis provision module and display the received result; and provided with the point from the point provision module according to the result of the determination.

The sports game data provision module and the prediction value analysis provision module may be operated in synchronization with each other with reference to the sports game that is occurring in real-time basis.

The prediction value analysis provision module may be configured to: receive, from the user terminal, a real-time prediction value about a sub-event of the sports game and a prior prediction value about a final outcome of the sports game, determine whether each is met or not, and provide a result of the determination to the user terminal.

The prediction value analysis provision module may be configured to: analyze by comparison the sports game data collected in real-time basis from the sports game data and the prediction value received from the prediction value analysis provision module, to perceive whether or not the sub-event is successful.

According to another exemplary embodiment, a participative sports game method by real-time analysis and prediction is provided, which may include collecting, at the server, a sports game data corresponding to a game record generated in real-time basis during the sports game; providing, at the server in real-time basis, a stream of a video of the sports game to the user terminal, and providing the collected sports game data to the user terminal; receiving, at the server, a prediction value about the sports game from the user terminal, determining whether or not the received prediction value is met, and providing a result of the determination to the user terminal; and providing, at the server, a point according to the result of the determination to the user terminal.

The receiving, at the server in real-time basis, the prediction value of the sports game from the user terminal, determining whether or not the received prediction value is met, and providing the result of the determination to the user terminal may include receiving a real-time prediction value about a sub-event of the sports game and a prior prediction value about a final outcome of the sports game, determine whether each is met or not, and provide a result of the determination to the user terminal.

The receiving, at the server in real-time basis, the prediction value of the sports game from the user terminal, determining whether or not the received prediction value is met, and providing the result of the determination to the user terminal may include analyzing by comparison the sports game data collected in real-time basis from the sports game data and the prediction value received from the prediction value analysis provision module, to perceive whether or not the sub-event is successful.

### Advantageous Effects

As described above, a participative sports game system and method by real-time analysis and prediction receive user's prediction in real-time basis on a sub-event (i.e., real-time records generated during the game) during a sports game broadcasting, and provide the result of determination whether the user's prediction is met or not, and therefore, allows the user to directly participate in the sports game and watch and enjoy the game. The user is able to enjoy not only the dynamic area of the sports game, but also intellectual area. Further, the user can also have increased understanding on the sports game, thus identify himself as one of the players and is more immersed into the game.

### BRIEF DESCRIPTION OF THE DRAWINGS

FIG. 1 is a block diagram of a participative sports game system by real-time analysis and prediction, according to a first exemplary embodiment.

FIG. 2 is a schematic diagram provided to explain pitchers' sub-event and hitter's sub-event, according to a first exemplary embodiment.

FIGS. 3A to 3C exemplify an interface screen provided for the real-time analysis and prediction in a baseball game, according to a first exemplary embodiment.

FIG. 4 exemplifies an interface screen provided for a real-time analysis and prediction in a volleyball game, according to a first exemplary embodiment.

FIG. 5 is a block diagram of a participative sports game system by real-time analysis and prediction according to a second exemplary embodiment.

FIG. 6 exemplifies an interface screen provided for a real-time analysis and prediction in a baseball game, according to a second exemplary embodiment.

FIG. 7 is a flowchart of a participative sports game method by real-time analysis and prediction according to an exemplary embodiment.

### MODE FOR CARRYING OUT THE INVENTION

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail. Further, terms and expressions described herein are defined in consideration of the functions in the present disclosure, and may change depending on the intention of a user or an operator, or relations. Accordingly, these will have to be defined based on the overall content of the present disclosure.

The like reference numerals are used to refer to same or similar elements in the drawings.

The terms such as “first,” “second,”, “A,” “B,” and so on may be used to describe a variety of elements, but the elements should not be limited to the terms. These terms are used solely for the purpose of distinguishing one element from another element.

For example, without departing from the scope of the present disclosure, a “first element” may be named a “second element”, and similarly, a “second element” may be named a “first element”. The expression “and/or” encompasses a combination of a plurality of associated items described herein or any of a plurality of associated items described herein.

When a certain element is stated as being “connected” or “coupled” to another element, it is to be understood that there is another intervening element present therebetween.

When a certain element is stated as being “directly connected” or “directly coupled” to another element, however, it is to be understood that there is no other intervening element present therebetween.

The terms are used herein only to describe certain exemplary embodiments, and these do not limit the present disclosure. A singular expression, unless otherwise specified in context, encompasses a plural expression.

The term such as “comprise” or “have” as used herein is to designate a presence of a characteristic, number, step, operation, element, component, or a combination of these, and not to foreclose a presence or possibility of adding one or more of other characteristics, numbers, steps, operations, elements, components or a combination of these.

Unless otherwise defined, all the terms used herein, including technical and scientific terms, have the same meaning as generally understood by those skilled in the art.

The terms such as those defined in a generally-used dictionary will be interpreted as having the meaning that matches the meaning in the related technological context, and unless otherwise defined specifically, will not be interpreted as having ideal or excessively formal meaning.

Herein below, exemplary embodiments of the present disclosure will be described in detail with reference to accompanying drawings.

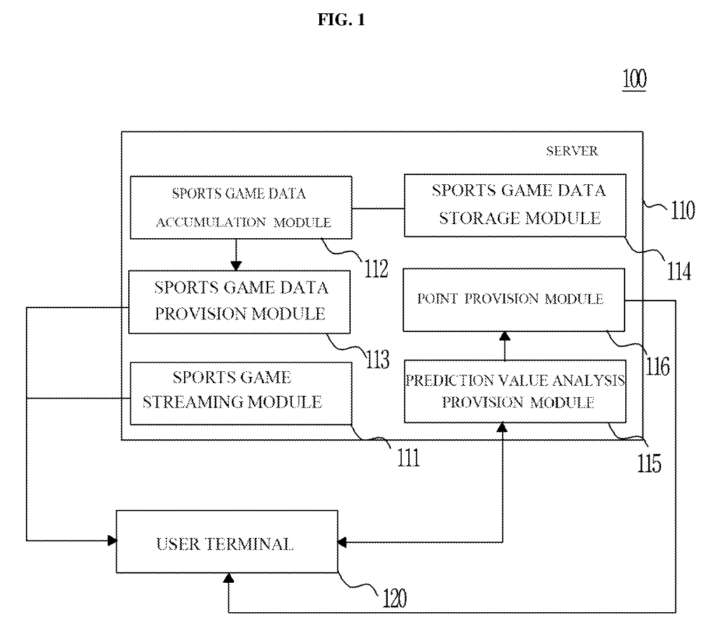

FIG. 1 is a block diagram of a participative sports game system by real-time analysis and prediction, according to a first exemplary embodiment.

Referring to FIG. 1, a participative sports game system 100 by real-time analysis and prediction (herein below, ‘participative sports game system’) according to a first exemplary embodiment includes a server 110 and a user terminal 120.

The server 110 may be configured to include a sports game streaming module 111, a sports game data accumulation module 112, a sports game data storage module 113, a sports game data provision module 114, a prediction value analysis provision module 115, and a point provision module 116.

The user terminal 120 may be configured as a terminal capable of bi-direction communication, such as not only a personal computer 120, but also a tablet PC, a smart phone, and so on.

The participative sports game system 100 is configured to allow a user to participate in the sports game by analyzing the flow of the game and predicting the outcome of the game in every moment of watching the sports game. The predictive sports game system 100 is also configured to allow a user to participate in the game such that the final result of the sports game, i.e., performances of each player and records made in the sports game are predicted in advance of the game. The user not only has the emotional satisfaction by being in the sports game, but also is more immersed in the game and enjoy every moment with increased intellectual fun.

Hereinbelow, detailed configurations will be described.

The sports game streaming module 111 may be configured to provide the user terminal 120, by streaming, with the video of a sports game selected by the user in real-time basis.

The sports game may be a baseball, a volleyball, a basketball, a football, or a variety of other games.

The sports game data accumulation module 112 may be configured to gather the match records generated in real-time in the sports game (i.e., sports game data) and accumulate the data. The sports game data may include a sub-event occurring in real-time during sports game, i.e., real-time record generated during the game, or the final result of the sports game, i.e., a variety of individual performance and records that are generated after the game finishes.

The sports game data storage module 113 may be configured to store the sports game data gathered at the sports game data accumulation module 112. The stored sports game data may be used for the purpose of accumulating individual performances, outcome of the game, and so on.

The sports game data provision module 114 may be configured to provide the sports game data gathered at the sports game data accumulation module 112 to the user terminal 120 in real-time basis.

The user terminal 120 may be configured to be provided with streams of video in real-time basis from the sports game streaming module 111 and display the same.

Additionally, the user terminal 120 may be configured to be provided with the sports game data associated with the sports game in real-time basis from the sports game data provision module 114 and display the same.

In this case, the sports game may be provided in streams via 3G/4G network or wiry network, and should be provided via a network capable of bi-directional communication.

The prediction value analysis provision module 115 may be configured to receive a prediction value for the sports game based on the video provided from the sports game streaming module 111, determine whether the received prediction value is met or not, and provide the result of the determination to the user smart terminal 120.

The “prediction value” as used herein may refer to either a real-time prediction value for a sub-event of a sports game, or a prior prediction value for a final game outcome of a sports game, or both.

In this case, the user terminal 120 may be configured to receive an input from a user regarding a real-time prediction value for every sub-event of a video sports game or receive, in advance, an input from a user regarding a prior prediction value for a final outcome of a sports game (e.g., a variety of individual performances and records generated in the game after the game finishes), and transmit the received data to the prediction value analysis provision module 115.

The prior prediction value may include a variety of individual performances and records generated in the game after the game finishes.

The sub-event (real-time records generated during the game) is detailed game result (i.e., various records) generated in the game at a hitter's box on the side of a batting team for a baseball game, such as, whether a hitter reaches the bases or not (e.g., hits, homeruns, walks, four balls, etc.), for example. Additionally, on the side of the defense team, the sub-event would correspond to determination as to a type and a quality of a ball the pitcher throws from a mound, to which location with reference to the pitching zone the ball is thrown, and so on.

In the example of volleyball, the sub-event on the side of offense team may be the event before a server serves a ball, such as, which spot with reference to a serve zone the server is going to serve the ball, methods and types of attacks (a, b, c, d quick back attack, etc.), and so on. On the side of the defense team, the sub-event may be established as to every possible outcome including whether or not a blocking defense would be successful.

Meanwhile, games like soccer or basketball are not suitable for making real-time predictions or analysis on the sub-events as described above. In this case, the predictions may be made after the game finishes, on a variety of events based on the individual performances and records generated during the game.

The prediction value analysis provision module 115 may be configured to determine as to whether or not the real-time prediction value and the prior prediction value are met, and provide the result of the determination to the user terminal 120.

The real-time analysis value will be exemplified in more detail.

When a user predicts a circumstance of an offense team in a baseball game, he or she may select two systems, i.e., waiting and swing. Considering the rules of the baseball, the rule that a hitter is out may be applied as a basis. That is, since the time when the hitter enters a hitter's box, the user may predict circumstances in every pitch by selecting between the waiting and the swing, based on the ball thrown by the pitcher. At this time, when the swing is selected, with the hitter hitting the ball, points may be obtained according to the points given to the respective records according to whether or not the hitter gets to the bases (e.g., respective records, four balls, walk, first base, second base, third base, homerun, run, foul, ground ball out, fly out, double out, sacrifice batting, sacrifice bunt, and so on). Moreover, configuration may be provided, in which whether or not a hitter would get to the bases (e.g., respective records, four balls, walk, first base, second base, third base, homerun, run, foul, ground ball out, fly out, double out, sacrifice batting, sacrifice bunt, and so on) may be inputted before the hitter enters the hitter's box. Further, according to another configuration, all number of possibilities that can be occurred in a game situation may be designated with a scoring system such that each may be selected and given corresponding points. According to yet another configuration, a user may be enabled to predict strategies for a variety of circumstances while a runner is being on the base (e.g., possibility as to whether the runner would steal a base, hit-and-run, squeeze, fake bunt, sacrifice hit, and so on). Meanwhile, when predicting on the side of a defense team of a baseball game, in one configuration, the user may be enabled to predict to which location with reference to the pitching zone the ball is going to be thrown, by predicting and selecting a type of a ball thrown by the pitcher (e.g., two seam, four seam, cutter, splitter, curve, sinker, circle changeup, palm ball, knuckle ball, slider, screw ball, and so on). Such predictions may be enabled by analyzing the type of the ball based on a trajectory of the ball from the time when the pitcher starts to throw the ball (i.e., the time the pitcher releases the ball) to the time when the ball reaches the home plate, as analyzed through a pitch tracking system appearing on the broadcast program.

Further, the manner in which the pitcher outs the hitter in a circumference occurring during the game may also be the subject to be predicted. For example, strikeouts, infield grounders, infield and outfield fly outs, double plays, and so on may be predicted in advance.

The volleyball will be described by way of another example. On a side of an offense team in the volleyball game, configuration may be provided to enable prediction on a direction of a serve by a server or whether or not the serve would be successful, a pattern of the attack (i.e., whether the attack would be a, b, c swift attack, back-court attack, attack in motion), and so on. On a side of a defense team, prediction may be made in advance on a defensive part such as whether or not a blocking is successful, and so on. Additionally, the configuration may be provided, which enables a user to make prediction on the individual records of each player before the game starts. That is, the prediction may be made on the individual's performance of each player as recorded according to the rules of the volleyball, such as, individual scores, serve score, open attack, back-court attack, swift attack score, number of blockings, number of receives, and so on.

Further, the configuration may be provided, which enables a user to predict on the form of attack by a receiving team every time the attack is made. The prediction may also be made on both whether the attack and defense would be successful or failed.

The prediction value analysis provision module 115 may be configured to accumulate, through a data accumulation management server that collects real-time records of the game occurring in the game, the records on the actual circumstances, and through the sports participative module, analyze by comparison the record values appearing in the actual circumstances with the prediction values and allows a user to perceive whether or not the sub-event is successful. The configuration may preferably be provided such that the records generated in the game, i.e., the results of the sub-event are either inputted by real-time basis or corrected through the manager terminal.

The prediction value analysis provision module 115 may be configured to provide the statistics from the results of determination described above to the user terminal 120.

The user terminal 120 may be configured to receive the results of the determination and the corresponding statistics from the prediction value analysis provision module 115 and display the same.

That is, it is possible that the statistics may be generated and provided with the game data of each team, and the statistics may also be generated and provided for each player. The results may also be provided based on the comparison between the game data statistics and the prediction statistics.

The point provision module 116 may be configured to provide the user terminal 120 with points according to the results of the determination provided from the prediction value analysis provision module 115.

The user terminal 120 may be configured to receive the points according to the results of the determination from the point provision module 116.

The point provision module 116 may post advertisements on the sites that show sports games, receive cash points of a corresponding company or real cash from the sponsor company and provide the same to the users.

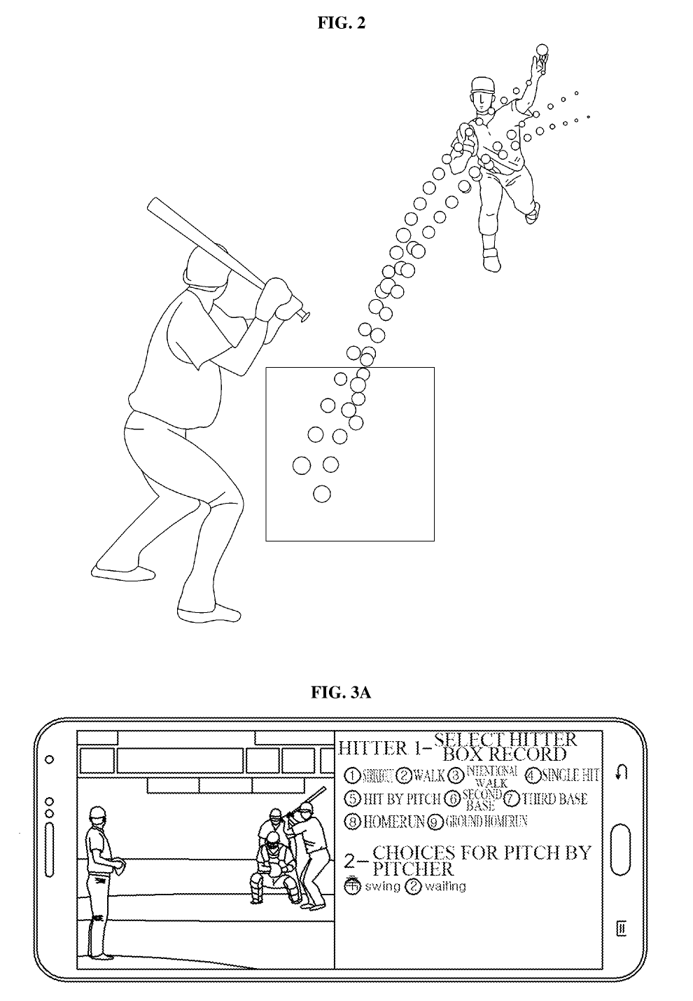

FIG. 2 is a schematic diagram provided to explain pitchers' sub-event and hitter's sub-event, according to a first exemplary embodiment.

Referring to FIG. 2, first, on the side of a hitter, prediction may be made on whether the hitter would make swing or waiting against the pitcher's pitch. According to the rules of the baseball, the hitter is out when he has three strikes. Accordingly, basically three swing predictions are possible. Further, because the hitter gets to a base by four balls by the rules of the baseball, basically four waiting predictions are possible.

On the side of the hitter, prediction is possible with the swing and the waiting for every ball the pitcher throws. When the hitter hits against the ‘swing’ prediction, points may be acquired by the corresponding records.

In contrast, on the side of the pitcher, configuration may be provided to enable a user to predict the type of the ball every time before the pitcher is going to throw the ball. The configuration may also allow the user to predict to which spot the ball is going to be thrown, after making the prediction on the type of the ball.

The configuration may be provided, in which points are acquired when the prediction on the type of the ball by the pitcher and the prediction values for the ball thrown in the pitching zone are successful in every pitch. The predictions on the type of the ball of the pitcher and the spot to which the ball is going to be thrown may be analyzed through the broadcast pitch tracking system.

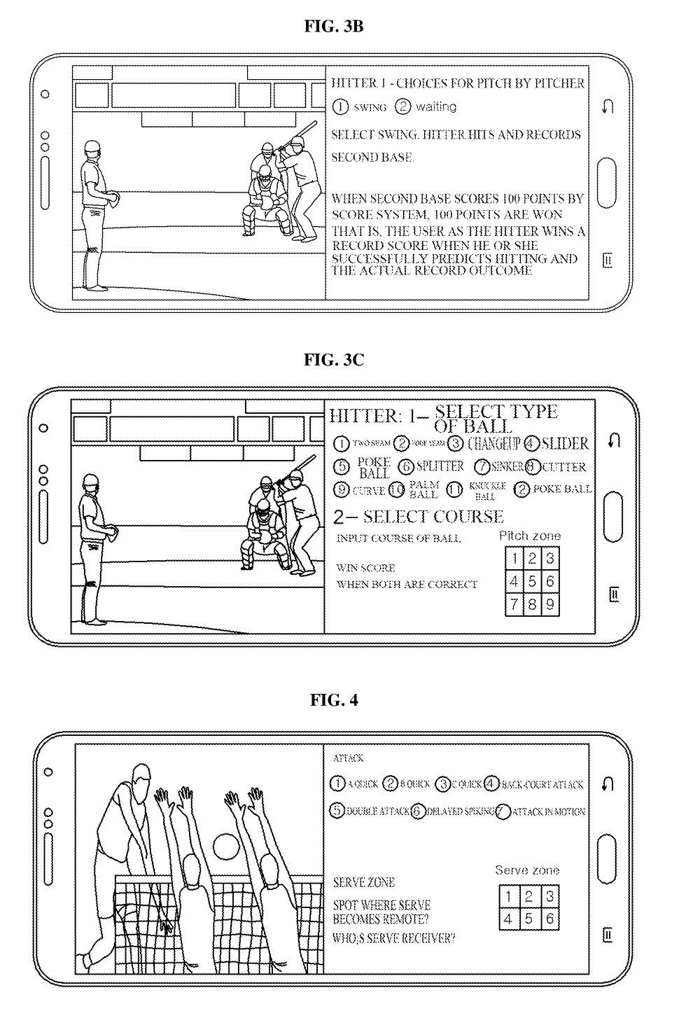

FIGS. 3A to 3C exemplify an interface screen provided for the real-time analysis and prediction in a baseball game, according to a first exemplary embodiment.

Referring to FIG. 3A, illustrated is an interface screen provided for a user to make selection on the pitching zone of the pitcher, in a baseball game. That is, strikeout, four balls, intentional walk, single hit, hit by pitch, and so on are illustrated, and the interface screen is configured to allow a user to select between whether the hitter would make swing or waiting.

Referring to FIG. 3B, after the selection between swing and waiting is made regarding the pitch of the pitcher, the points provided as a result are exemplified.

Referring to FIG. 3C, an interface screen on the side of a pitcher is exemplified, which is provided for predicting which type of ball would be thrown. As illustrated, selection may be made among two seam, four seam, changeup, poke ball, splitter, sinker, cutter, curve, palm ball, knuckle ball, and so on, and the pitch zone of the ball is also selectable.

FIG. 4 exemplifies an interface screen provided for a real-time analysis and prediction in a volleyball game, according to a first exemplary embodiment.

Referring to FIG. 4, as illustrated, a type of attack in a volleyball is selectable, and the serve zone is also selectable. The type of attack may include A quick, B quick, C quick, back-court attack, double attack, delayed spike, attack in motion, and so on.

### DESCRIPTION OF EMBODIMENTS

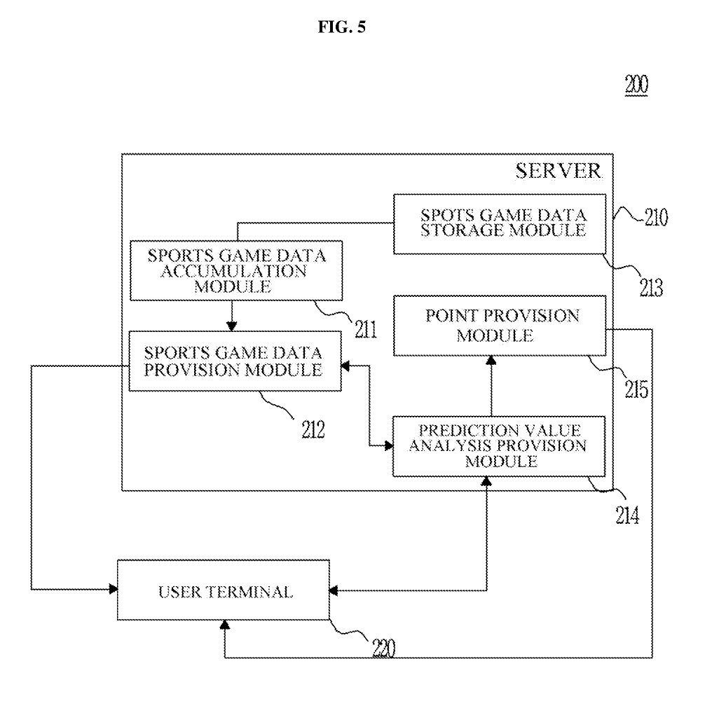

FIG. 5 is a block diagram of a participative sports game system by real-time analysis and prediction according to a second exemplary embodiment.

Referring to FIG. 5, the participative sports game system (herein below, ‘participative sports game system’) 200 by real-time analysis and prediction according to a second exemplary embodiment of the present disclosure includes a server 210 and a user terminal 220.

The server 210 may be configured to include a sports game data accumulation module 212, a sports game data storage module 213, a sports game data provision module 214, a prediction value analysis provision module 215, and a point provision module 216.

Unlike the server 110 according to the first exemplary embodiment, the server 210 does not include a sports game streaming module. That is, the user terminal 220 may be different in that the user terminal 220 receives in real-time basis only the game data, and does not receive the image of the game that is currently occurring. However, the user terminal 220 may be configured to determine and comprehend, in real-time basis, the current game data through a certain interface screen.

Additionally, like the first exemplar embodiment the user terminal 220 may be configured as a terminal capable of bi-direction communication, such as not only a personal computer 120, but also a tablet PC, a smart phone, and so on.

The participative sports game system 200 is configured to allow a user to participate in the sports game by analyzing the flow of the game and predicting a result of every moment of the game, while watching the sports game.

Like the first exemplary environment, the user may make prediction in every moment of the currently-occurring game event and acquire points. Although the image of the currently-occurring game event is not streamed and displayed on the user terminal 220, because the current game records or game data are still provided in real-time basis to the user terminal 120, the user is still able to analyze the current flow of the game and game records in real-time basis. Further, the user is able to participate in the game through the user terminal 220, while he is watching the game in the stadium, or through television or other image media.

Hereinbelow, the detailed configurations will be described.

The sports game data accumulation module 211 may be configured to collect the game records, i.e., sports game data occurring in real-time basis in the sports game and accumulate the same. The sports game data may include the sub-event occurring in real-time in the sports game, i.e., the real-time records occurring during the game, and the final result of the sports game, i.e., a variety of individual performances and records generated after the game finishes.

The sports game data accumulation module 211 may be configured to receive, in real-time basis, the sports game data through the server manager or the sports game data input terminal (not illustrated).

The sports game data storage module 222 may be configured to store the sports game data collected at the sports game data accumulation module 211. The stored sports game data may be utilized for the purpose of individual performance accumulation, or win/lose accumulation.

The sports game data provision module 212 may be configured to provide the sports game data collected at the sports game data accumulation module 211 to the user terminal 220.

In addition, the user terminal 220 may be configured to receive, in real-time basis, the sports game data associated with the sports game from the sports game data provision module 212 and display the same on a certain interface screen.

The sports game data storage module 213 may be configured to backup store the sports game data accumulated at the sports game data accumulation module 211.

The prediction value analysis provision module 214 may be configured to receive the prediction values made by the user for the currently-occurring game event, determines whether the received prediction values are met or not, and provide the result of the determination to the user terminal 220.

The “prediction value” as used herein may refer to either a real-time prediction value for a sub-event of a sports game, or a prior prediction value for a final game outcome of a sports game, or both.

In this case, the user terminal 220 may be configured to receive an input from a user regarding a real-time prediction value for every sub-event of a video sports game or receive, in advance, an input from a user regarding a prior prediction value for a final outcome of a sports game (e.g., a variety of individual performances and records generated in the game after the game finishes), and transmit the received data to the prediction value analysis provision module 115. The prior prediction value may include a variety of individual performances and records generated in the game after the game finishes.

The sub-event (real-time records generated during the game) is detailed game result (i.e., various records) generated in the game at a hitter's box on the side of a batting team for a baseball game, such as, whether a hitter reaches the bases or not (e.g., hits, homeruns, walks, four balls, etc.), for example. Additionally, on the side of the defense team, the sub-event would correspond to determination as to a type and a quality of a ball the pitcher throws from a mound, to which location with reference to the pitching zone the ball is thrown, and so on.

In the example of volleyball, the sub-event on the side of offense team may be the event before a server serves a ball, such as, which spot with reference to a serve zone the server is going to serve the ball, methods and types of attacks (a, b, c, d quick back attack, etc.), and so on. On the side of the defense team, the sub-event may be established as to every possible outcome including whether or not a blocking defense would be successful.

The prediction value analysis provision module 214 may be configured to determine whether or not each of the real-time prediction value received from the prediction value analysis provision module 214 and the prior prediction value is met, and provide the result of the determination to the user terminal 220.

In a certain example, the sports game data provision module 212 and the prediction value analysis provision module 214 have to be in real-time synchronization with each other. These may be configured to be in synchronization with the progress of the actual game such that the prediction value analysis provision module 214 receives prediction value from the user terminal 220 before the sub-event is occurred in the actual game, and the sports game data provision module 212 provides the user terminal 220 with the actual outcome of the corresponding sub-event after the corresponding sub-event is occurred.

Accordingly, the server 210 may receive, in real-time basis, the video of the game from outside, and the sports game data provision module 212 and the prediction value analysis provision module 214 are preferably configured to be in synchronization with each other based on the video of the game that is provided in real-time basis.

The real-time prediction values of the baseball game or volleyball game have already been described above with reference to the first exemplary embodiment, and thus will not be redundantly described below for the sake of brevity.

Meanwhile, the prediction value analysis provision module 214 may be configured to provide the statistics of the results of the determination provided as described above, to the user terminal 220.

The user terminal 220 may be configured to be provided with the result of the determination and the corresponding statistics from the prediction value analysis provision module 214 and display the same.

That is, it is possible that the statistics may be generated and provided with the game data of each team, and the statistics may also be generated and provided for each player. The results may also be provided based on the comparison between the game data statistics and the prediction statistics.

The point provision module 215 may be configured to provide the user terminal 220 with points according to the results of the determination provided from the prediction value analysis provision module 214.

The user terminal 220 may be configured to receive the points according to the results of the determination from the point provision module 215.

The point provision module 215 may post advertisements on the sites that show sports games, receive cash points of a corresponding company or real cash from the sponsor company and provide the same to the users.

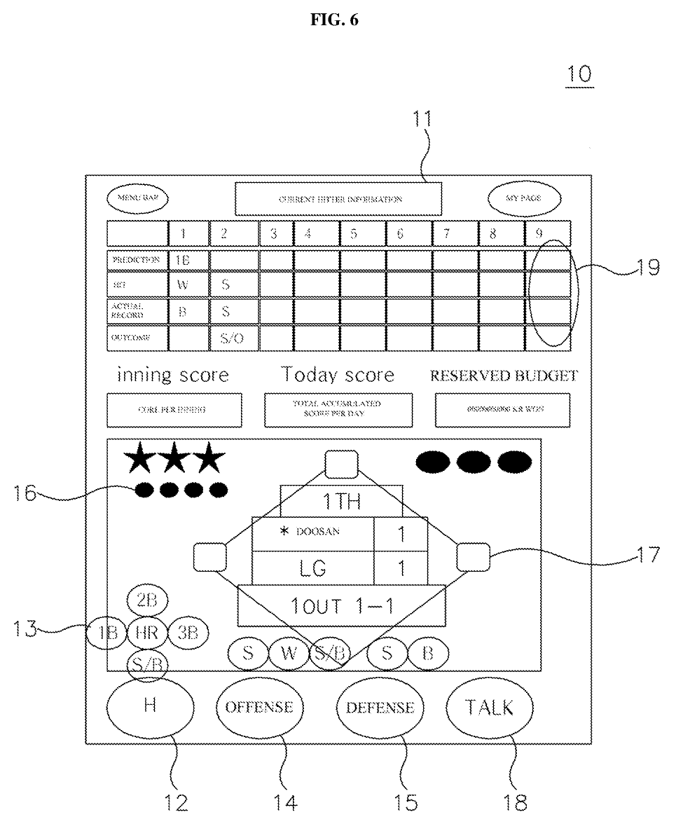

FIG. 6 exemplifies an interface screen provided for a real-time analysis and prediction in a baseball game, according to a second exemplary embodiment.

As illustrated in FIG. 6, the interface screen of FIG. 6 is free of a streaming video, and thus is configured to allow the user to determine the current flow of the game with increased ease and accuracy. That is, the interface screen is configured to allow the user to determine the current flow of the game without watching the video of the game, and also configured such that the user is able to predict the current sub-event of the baseball game, such as, every batting or pitching and find out the outcome thereof.

The interface screen 10 in FIG. 6 may be composed of a current hitter introduction area 11, a hitter box outcome prediction button 12, a prediction button 13 for every pitch from a hitter's box (shortly, ‘hitter box prediction button’), an attack button 14, a defense button 15, a sub-record button 16, an overall match progress button 17 (shortly, ‘game status button’), a dialogue button 18 with a counterpart (shortly, ‘counterpart dialogue button’), and an area for hitter record per pitch.

The current hitter introduction area 11 presents information about a hitter currently in the hitter's box.

When the hitter box button 12, represented by ‘H’ button, is pressed, the button for inputting prediction on the outcomes in the hitter's box appears on the top.

The hitter box prediction button 13 is pressed by the user in order to predict records of a hitter in the hitter's box. That is, the user is able to predict that the hitter in the hitter's box would get to the first base, second base, and so on, by pressing one of the hitter box prediction button 13.

The attack button 14 is provided to enable the user to select whether the hitter would swing or it would be a ball, squeeze bunt or bunt, and so on, when the user's team is an offense team. The user may make such selection by selectively pressing the sub-buttons appearing above the attack button 14.

The defense button 15 is provided for a user to select whether the pitch of the pitcher is a ball or a strike, when the user's team is a defense team.

The sub-record button 16 shows rights to select, e.g., three hits for the hitter, four balls, and so on.

The game status button 17 may be configured to appear when the hitter box button 12 is pressed, and also configured to display information about the offense team and the defense team in the current game situation, along with a ball count of the hitter, outcount of the team, score, current inning, and so on.

The counterpart dialogue button 18 is provided for the user to initiate a dialogue function that allows the user to have dialogue with other users currently participating in the league.

The area 19 for recording hitter record per pitch is where the actual records of the hitter against every pitcher appears. In this area, the values predicted and inputted by the user regarding final outcomes of the hitting player in the hitter's box, or actual pitch values predicted and inputted for every pitch, or the actual outcome (point) in the hitter's box are appeared per pitch.

The interface screen described above allows the user to determine, predict and keep enjoying the game based on the game data recorded in every moment, i.e., without actually watching the image of the game.

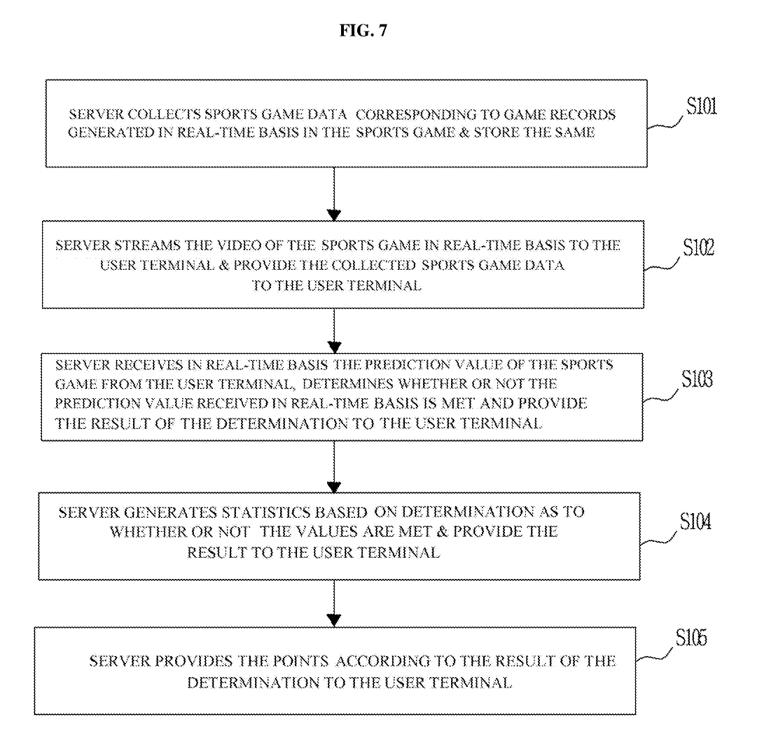

FIG. 7 is a flowchart of a participative sports game method by real-time analysis and prediction according to an exemplary embodiment.

Referring to FIG. 7, first, at S101, the sports game data accumulation module 112 of the server 110 collects the sports game data corresponding to the game record occurring in real-time basis in the sports game and stores the same.

At 102, the sports game streaming module 111 provides a stream of the video of the sports game to the user terminal 120 in real-time basis, and the sports game data provision module 114 of the server 110 provides the sports game data associated with the video to the user terminal 120 in real-time basis.

Next, at S103, the prediction value analysis provision module 115 of the server 110 receives, in real-time basis, the prediction values of the sports game from the user terminal 120, determines whether the prediction values received in real-time basis are met or not, and provide the result of the determination to the user terminal.

At this time, the prediction value analysis provision module 115 of the server 110 may be configured to receive from the user terminal 120 either a real-time prediction value for a sub-event of a sports game, or a prior prediction value for a final game outcome of a sports game, and determine whether each is met.

In addition, the prediction value analysis provision module 115 of the server 110 may be configured to provide the result of the determination to the user terminal 120.

Further, the prediction value analysis provision module 115 may be configured to perceive whether the sub-event is successful or not, by comparison-analyzing the sports game data collected in real-time basis at the sports game data accumulation module 112 with respect to the prediction value received from the prediction value analysis provision module 115.

Next, at S104, the prediction value analysis provision module 115 of the server 110 generates the statistics of the results of the determination and provide the generated statistics to the user terminal 120.

Next, at S105, the point provision module 116 of the server 110 provides the points according to the result of the determination to the user terminal 120.

The foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

### INDUSTRIAL APPLICABILITY

The present disclosure relates to a sports game system and method and is applicable to a game industry.

1. A participative sports game system by real-time analysis and prediction, comprising:
a server comprising:
a sports game streaming module configured to provide, in real-time basis, a stream of a video of a sports game selected by a user;
a sports game data accumulation module configured to collect a sports game data corresponding to a game record generated in real-time basis during the sports game;
a sports game data provision module configured to provide, in real-time basis, the collected sports game data of the sports game;
a sports game data storage module configured to store the sports game data collected in real-time basis;
a prediction value analysis provision module configured to receive a prediction value about the sports game from the video provided by the sports game streaming module, determine whether or not the received prediction value is met and provide a result of the determination; and
a point provision module configured to provide a point according to the result of the determination provided from the prediction value analysis provision module; and
a user terminal configured to be:
provided with the stream of the video in real-time basis from the sports game streaming module and display the received video;
provided with the sports game data in real-time basis from the sports game data provision module and display the received data;
inputted with the prediction value about the video of the sports game from the user and transmit the received value to the prediction value analysis provision module;
provided with the result of the determination from the prediction value analysis provision module and display the received result; and
provided with the point from the point provision module according to the result of the determination,
wherein the prediction value analysis provision module is configured to: receive, from the user terminal, a real-time prediction value of a sub-event of the sports game composed of a real-time record generated in real-time basis in the sports game, and analyze, by contrast and comparison, a sports game data collected in real-time basis from the sports game data with a prediction value for sub data received in real-time basis from the prediction value analysis provision module to determine, in real-time basis, whether the prediction about the sub-event is accurate or not, and provide a result of the determination to the user terminal in real-time basis.

2. The participative sports game system of claim 1, wherein, when the sports game is a baseball, the sub-event is composed of information as to: whether a type of a ball thrown by every pitching of a pitcher is a two seam, a four seam, a cutter, a splitter, a curve, a sinker, a circle changeup, a palm ball, a knuckle ball, a slider, or a screw ball, in which position of a pitching zone the pitcher is performing every pitching, and a timing of replacing the pitcher and who is a replacement pitcher; and information as to, at every bat, whether a hitter gets onto bases, is out, makes waiting, swing, a hit, a homerun, a single hit, a two-base hit, a three-base hit, a hit and run, a sacrifice bunt, a strikeout, a double out, a ground out, a fly out, or a foul, or whether or not a runner steals a base, or
when the sports game is a volleyball, the sub-event is composed of information as to: whether or not an offense team scores, to which serve zone a serve goes, whether an attack is an A quick attack, a B quick attack, a C quick attack, a D quick attack, or a back attack, and whether or not a defense team scores, and whether or not a blocking is successful.

3. (canceled)

4. A participative sports game method by real-time analysis and prediction, comprising:
collecting, at a server, a sports game data corresponding to a game record generated in real-time basis during the sports game;
providing, at the server in real-time basis, a stream of a video of the sports game to the user terminal, and providing the collected sports game data to the user terminal;
receiving, at the server, a prediction value about the sports game from the user terminal, determining whether or not the received prediction value is met, and providing a result of the determination to the user terminal; and
providing, at the server, a point according to the result of the determination to the user terminal,
wherein the receiving, at the server in real-time basis, the prediction value of the sports game from the user terminal, determining whether or not the received prediction value is accurate, and providing the result of the determination to the user terminal comprises,
receiving, at the server, a real-time prediction value of a sub-event of the sports game composed of a real-time record generated in real-time basis in the sports game, and analyzing, by contrast and comparison, a sports game data collected in real-time basis from the sports game data with a prediction value for sub data received in real-time basis from the prediction value analysis provision module to determine, in real-time basis, whether the prediction about the sub-event is accurate or not, and providing a result of the determination to the user terminal in real-time basis.

5. The participative sports game method of claim 4, wherein, when the sports game is a baseball, the sub-event is composed of information as to: whether a type of a ball thrown by every pitching of a pitcher is a two seam, a four seam, a cutter, a splitter, a curve, a sinker, a circle changeup, a palm ball, a knuckle ball, a slider, or a screw ball, in which position of a pitching zone the pitcher is performing every pitching, and a timing of replacing the pitcher and who is a replacement pitcher; and information as to, at every bat, whether a hitter gets onto bases, is out, makes waiting, swing, a hit, a homerun, a single hit, a two-base hit, a three-base hit, a hit and run, a sacrifice bunt, a strikeout, a double out, a ground out, a fly out, or a foul, or whether or not a runner steals a base, or
when the sports game is a volleyball, the sub-event is composed of information as to: whether or not an offense team scores, to which serve zone a serve goes, whether an attack is an A quick attack, a B quick attack, a C quick attack, a D quick attack, or a back attack, and whether or not a defense team scores, and whether or not a blocking is successful.

6. (canceled)

7. A participative sports game system by real-time analysis and prediction, comprising:
a server comprising:
a sports game streaming module configured to provide, in real-time basis, a stream of a video of a sports game selected by a user;
a sports game data accumulation module configured to collect a sports game data corresponding to a game record generated in real-time basis during the sports game;
a sports game data provision module configured to provide, in real-time basis, the collected sports game data of the sports game;
a sports game data storage module configured to store the sports game data collected in real-time basis;
a prediction value analysis provision module configured to receive a prediction value about the sports game from the video provided by the sports game streaming module, determine whether or not the received prediction value is met and provide a result of the determination; and
a point provision module configured to provide a point according to the result of the determination provided from the prediction value analysis provision module; and
a user terminal configured to be:
provided with the sports game data in real-time basis from the sports game data provision module and display the received data;
inputted with the prediction value about the video of the sports game from the user and transmit the received value to the prediction value analysis provision module;
provided with the result of the determination from the prediction value analysis provision module and display the received result; and
provided with the point from the point provision module according to the result of the determination,
wherein the sports game data provision module and the prediction value analysis provision module are operated in synchronization with each other with reference to the sports game that is occurring in real-time basis, and the prediction value analysis provision module is configured to: receive, from the user terminal, a real-time prediction value of a sub-event of the sports game composed of a real-time record generated in real-time basis in the sports game, and analyze, by contrast and comparison, a sports game data collected in real-time basis from the sports game data with a prediction value for sub data received in real-time basis from the prediction value analysis provision module to determine, in real-time basis, whether the prediction about the sub-event is accurate or not, and provide a result of the determination to the user terminal in real-time basis.

8. The participative sports game system of claim 7, wherein, when the sports game is a baseball, the sub-event is composed of information as to: whether a type of a ball thrown by every pitching of a pitcher is a two seam, a four seam, a cutter, a splitter, a curve, a sinker, a circle changeup, a palm ball, a knuckle ball, a slider, or a screw ball, in which position of a pitching zone the pitcher is performing every pitching, and a timing of replacing the pitcher and who is a replacement pitcher; and information as to, at every bat, whether a hitter gets onto bases, is out, makes waiting, swing, a hit, a homerun, a single hit, a two-base hit, a three-base hit, a hit and run, a sacrifice bunt, a strikeout, a double out, a ground out, a fly out, or a foul, or weather or not a runner steals a base, or
when the sports game is a volleyball, the sub-event is composed of information as to: whether or not an offense team scores, to which serve zone a serve goes, whether an attack is an A quick attack, a B quick attack, a C quick attack, a D quick attack, or a back attack, and whether or not a defense team scores, and whether or not a blocking is successful.

9. (canceled)
